(19) United States
(12) Patent Application Publication
(10) Pub. No.: US 2022/0197494 A1
(43) Pub. Date: Jun. 23, 2022

(54) DEVICES AND METHODS OF MULTI-SURFACE GESTURE INTERACTION

(71) Applicants: Wei LI, Richmond Hill (CA); Sachi MIZOBUCHI, Toronto (CA)

(72) Inventors: Wei LI, Richmond Hill (CA); Sachi MIZOBUCHI, Toronto (CA)

(21) Appl. No.: 17/127,825

(22) Filed: Dec. 18, 2020

(51) Int. Cl. G06F 3/0488; G06F 3/0485; G06F 3/041; G06F 3/0484

(52) U.S. Cl. CPC G06F 3/04883; G06F 3/0485; G06F 2203/04808; G06F 3/04845; G06F 3/041

(57) ABSTRACT

Devices and methods for controlling an electronic device are provided. The methods include recognizing a two finger input gesture on at least two touch sensitive surfaces of the electronic device and manipulating a slider control rendered on a display in response to recognizing the two finger input gesture. Recognizing the two finger input gesture includes detecting a first input gesture, including a swipe gesture on a first touch sensitive surface and detecting a second input gesture, including a static touch at a location on a second touch sensitive surface. The first input gesture and the second input gesture happen in a same time period. The static touch location may be a soft button of a plurality of buttons and the slider control may be rendered in response to the static touch on the soft button. The method may be used in an electronic device having multiple touchscreen displays.

### FIELD

This disclosure relates generally to electronic devices having one or more touch sensitive surfaces and more specifically to methods and devices for multi-surface gesture interaction for devices.

### BACKGROUND

Electronic devices include smartphones, tablets, laptop computers, desktop computers, and smart watches. Electronic devices may have touchscreen displays on which content is displayed. The content to be displayed may not all fit on the viewing area of the touchscreen display, and thus requires scrolling. When the content to be displayed is large, scrolling through the large content may be time consuming and inconvenient. A first solution for scrolling involves the use of touch flicks. A user touches the screen, typically with the tip of a finger, swipes up or down depending on the desired direction of scrolling, then lifts the finger off the screen. The speed by which the user swipes up or down determines the amount of scrolling effected. For example, a slow swipe, and accordingly a slow touch flick, may scroll the contents of the viewing area by a few lines, whereas a faster touch flick may scroll the contents of the viewing area by tens of lines in a short period of time. However, faster touch flicks and the resulting fast scrolling of the viewing area contents, renders the content unreadable during scrolling thus making it difficult to locate information within the content. Additionally, repeated touch flicks causes wear to the touch sensing systems of the touchscreen display.

Another option to scroll the contents of a viewing area of a touchscreen display is a scrollbar in which a user can drag a scrollbar thumb along a scrollbar track to scroll display contents. Due to the limited viewing area size on the display, the scrollbar is typically thin, which can cause unintended touches on the screen when the user intends to touch the scrollbar. In some cases, the scrollbar may contain jump buttons to provide the function of jumping to the top or bottom of the content. However, this may not be helpful if the user is interesting in information which is in the middle of the content, or looking for specific contents.

Slider user interface controls are typically associated with system parameters which change in value in response to swiping a finger along a track of the slider control between a first end corresponding to a minimum value and a second end corresponding to a maximum value of the system parameter. On touchscreen displays it is sometimes difficult to change the system parameters with accuracy using slider controls due to limited display real-estate. Furthermore, slider controls may be accidentally actuated if there is an unintended swipe along the track thereof.

There is a need for a system and method for scrolling screen contents which address at least some of the aforementioned problems. There is also a need for a system and a method for controlling slider controls on touchscreen displays which address at least some of the aforementioned problems.

### SUMMARY

The present disclosure generally relates to the use of finger gestures on devices with at least two touch sensitive surfaces to allow improved scrolling of display contents and accurate manipulation of slider user interface controls.

According to an aspect of the present disclosure, there is provided a method for controlling electronic device. The method comprises recognizing a two finger input gesture on at least two touch sensitive surfaces of the electronic device, including detecting a first input gesture, including a first direction, on a first touch sensitive surface; and detecting a second input gesture, including at least one of a second direction or a second location, on a second touch sensitive surface. The first input gesture and the second input gesture happen in a same time period. The method also comprises altering a content rendered on a display in response to recognizing the two finger input gesture.

The method enables efficient altering of content rendered on a display of an electronic device using finger gestures on two touch sensitive surfaces. This may, for example allow altering display content with fewer user interactions, thereby reducing possible wear or damage to the electronic device and possibly reducing battery power consumption. User experience may also be enhanced as triggering unintended actions is reduced since it is unlikely that simultaneous gestures on two touch sensitive surfaces may accidentally occur.

In some examples of the present disclosure, the first input gestures includes a first swipe gesture in the first direction, and the second input gesture includes a second swipe gesture in the second direction at the second location.

In some examples of the present disclosure, the first touch sensitive surface may comprise a touchscreen display which is the display on which the content is rendered.

In some examples of the present disclosure, altering the content rendered on the display may comprise scrolling a viewing area of the display in the first direction of the first swipe gesture when the second direction of the second swipe gesture is consistent with the first direction of the first swipe gesture.

In some examples of the present disclosure, altering the content rendered on the display may comprise scrolling a viewing area of the display in the first direction of the first swipe gesture with a scrolling speed determined by the second location of the second swipe gesture when the second direction of the second swipe gesture is opposite to the first direction of the first swipe gesture.

In some examples of the present disclosure, altering the content rendered on the display may comprise scrolling a viewing area of the display in the first direction with a scrolling speed associated with the first touch sensitive surface.

In some examples of the present disclosure, altering the content may comprise rotating an object on the display in response to the first swipe gesture and the second swipe gesture when the first direction is opposite to the second direction.

In some examples of the present disclosure, the first input gesture includes a first swipe gesture in the first direction, and the second input gesture includes a static touch at a location.

In some examples of the present disclosure, altering the content rendered on the display may comprise manipulating a user interface control in response to the first swipe gesture and the location of the static touch gesture.

In some examples of the present disclosure, altering the content rendered on the display may comprise automatic scrolling the content rendered on the display at a preconfigured magnitude when the second direction of the second swipe gesture is opposite to the first direction of the first swipe gesture.

According to another aspect of the present disclosure, there is provided an electronic device comprising a processor and a non-transitory memory coupled to the processor and storing instructions. The instructions when executed by the processor configure the processor to recognize a two finger input gesture on at least two touch sensitive surfaces of the electronic device, including detecting a first input gesture, including a first direction, on a first touch sensitive surface and detecting a second input gesture, including at least one of a second direction or a second location, on a second touch sensitive surface. The first input gesture and the second input gesture happen in a same time period. The instructions further configure the processor to alter a content rendered on a display in response to recognizing the two finger input gesture.

In some examples of the present disclosure, the first touch sensitive surface may comprise a touchscreen display which is the display on which the content is rendered.

In some examples of the present disclosure, the first input gesture includes a first swipe gesture in the first direction, and the second input gesture includes a second swipe gesture in the second direction at the second location.

In some examples of the present disclosure, to alter the content rendered on the display, the instructions may further configure the processor to scroll a viewing area of the display in the first direction when the second direction of the second swipe gesture is consistent with the first direction of the first swipe gesture.

In some examples of the present disclosure, to alter the content rendered on the display, the instructions may further configure the processor to scrolling a viewing area of the display in the first direction with a scrolling speed determined by the second location of the second swipe gesture when the second direction of the second swipe gesture is opposite to the first direction of the first swipe gesture.

In some examples of the present disclosure, to alter the content rendered on the display, the instructions may further configure the processor to rotate an object on the display in response to the first swipe gesture and the second swipe gesture.

In some examples of the present disclosure, the first input gesture includes a first swipe gesture in the first direction; and the second input gesture includes a static touch gesture at a location.

In some examples of the present disclosure, to alter the content rendered on the display, the instructions may further configure the processor to scroll a viewing area of the display in the first direction with a scrolling speed associated with the first touch sensitive surface.

In some examples of the present disclosure, to alter the content rendered on the display, the instructions may further configure the processor to manipulate a user interface control in response to the first swipe gesture and the location of the static touch gesture.

According to yet another aspect of the present disclosure, there is provided a non-transitory computer readable medium storing instructions which when executed by a process of an electronic device, configures the electronic device to recognize a two finger input gesture on at least two touch sensitive surfaces of the electronic device, including detecting a first input gesture, including a first direction, on a first touch sensitive surface and detecting a second input gesture, including at least one of a second direction or a second location, on a second touch sensitive surface. The first input gesture and the second input gesture happen in a same time period. The instructions further configure the processor to alter a content rendered on a display in response to recognizing the two finger input gesture.

The presented methods and devices provide for efficient scrolling of display content without the use of touch flicks thus reducing pressure on the touch sensing system and reducing wear device. The device and methods also reduce the need to display a dedicated scrollbar and thus requiring a larger display to display the same content. Using a smaller display reduces battery power consumption and lowers overall electronic device cost. Using synchronous gestures on two touch sensitive surfaces prevent accidental activation of actions, which may require additional corrective actions to cancel. The gestures described are simple and are comprised of swipes which are easy to recognize without complex computations thus reducing processing resources. Multiple slider controls may be controlled without the need to display all of them simultaneously. This conserves display area and reduces the need to make the display size larger thus reducing cost and power consumption.

### BRIEF DESCRIPTION OF THE DRAWINGS

Reference will now be made, by way of example, to the accompanying drawings which show example embodiments of the present application, and in which:

FIG. 1 is an example electronic device employing a touchscreen display;

FIG. 2 is a diagram depicting scrolling through content using a display;

FIG. 3 depicts scrolling through content on a touchscreen display of the electronic device of FIG. 1 using touch flicks;

FIG. 4 depicts scrolling through content on a touchscreen display of the electronic device of FIG. 1 using a scrollbar;

FIG. 5 depicts the electronic device of FIG. 1 featuring a front touchscreen display gesture response area, in accordance with example embodiments of the present disclosure;

FIG. 6 depicts the back side of an electronic device featuring a back touchscreen display having a back touchscreen display gesture response area, in accordance with embodiments of the present disclosure;

FIG. 7 depicts an example implementation of a same direction pinch slide gesture on the electronic device of FIG. 5, in accordance with embodiments of the present disclosure;

FIG. 8 depicts an example implementation of a same direction pinch slide gesture in an upward direction on the electronic device of FIG. 7, in accordance with example embodiments of the present disclosure;

FIG. 9 depicts the electronic device of FIG. 7 wherein the user's right hand performs an opposite direction pinch open slide gesture, in accordance with example embodiments of the present disclosure;

FIG. 10 depicts the electronic device of FIG. 7 wherein the user's right hand performs an opposite direction pinch close slide gesture, in accordance with example embodiments of the present disclosure;

FIG. 11 depicts an example implementation of pinch close slide gestures as in FIG. 10, in accordance with example embodiments of the present disclosure;

FIG. 12 depicts a back view of an electronic device featuring a back touch pad, in accordance with example embodiments of the present disclosure;

FIG. 13 is a perspective view of a foldable electronic device, in a tent configuration, having a front touchscreen display on a front housing portion, a back touchscreen display on a back housing portion and an edge display in accordance with example embodiments of the present disclosure;

FIG. 14 depicts an example implementation of a same direction pinch slide gesture on the foldable electronic device of FIG. 13, in accordance with example embodiments of the present disclosure;

FIG. 15 depicts another example implementation of a same direction sliding gesture on the foldable electronic device of FIG. 13, in accordance with example embodiments of the present disclosure;

FIG. 16 depicts an example implementation of an opposite direction sliding gesture on the foldable electronic device of FIG. 13, in accordance with example embodiments of the present disclosure;

FIG. 17 depicts an electronic device having a top display and a bottom display, and an example implementation of a two finger input gesture for manipulating a rotary slide control on the top display, in accordance with example embodiments of the present disclosure;

FIG. 18 depicts another example implementation of a two finger input gesture manipulating a linear slide control on the electronic device of FIG. 17, in accordance with example embodiments of the present disclosure;

FIG. 19 depicts yet another example implementation of a two finger input gesture for manipulating a rotary slide control on the electronic device of FIG. 17, in accordance with example embodiments of the present disclosure;

FIG. 20 depicts yet another example implementation of a two finger input gesture for manipulating a linear slide control on the electronic device of FIG. 17, in accordance with example embodiments of the present disclosure;

FIG. 21 depicts a block diagram of a processing device representative an electronic device which implements the methods of the present disclosure; and

FIG. 22 depicts a flow chart for a method for altering rendering contents of a touchscreen display.

### DESCRIPTION OF EXAMPLE EMBODIMENTS

Example embodiments are described herein that may in some applications mitigate against the shortcomings of the existing methods. The embodiments presented herein utilize two finger input gestures which involve simultaneous contact between the user's fingers and two touch sensitive surfaces. In some embodiments, the first touch sensitive surface and the second touch sensitive surface are touchscreen displays. In other embodiments, the first touch sensitive surface is a touchscreen display and the second touch surface is a touchpad. The two finger input gesture may in some cases be comprised of two swipes and in other cases of one swipe and a static touch. The two finger input gesture may be used to scroll content on a touchscreen display, or to manipulate a slider control user interface.

In this disclosure the term “electronic device” refers to an electronic device having computing capabilities. Examples of electronic devices include but are not limited to: personal computers, laptop computers, tablet computers (“tablets”), smartphones, surface computers, augmented reality gear, automated teller machines (ATM)s, point of sale (POS) terminals, and the like.

In this disclosure, the term “display” refers to a hardware component of an electronic device that has a function of displaying graphical images, text, and video content thereon. Non-limiting examples of displays include liquid crystal displays (LCDs), light-emitting diode (LED) displays, and plasma displays.

In this disclosure, a “screen” refers to the outer user-facing layer of a touchscreen display.

In this disclosure, the term “touchscreen display” refers to a combination of a display together with a touch sensing system that is capable of acting as an input device by receiving touch input. Non-limiting examples of touchscreen displays are: capacitive touchscreens, resistive touchscreens, and Infrared touchscreens and surface acoustic wave touchscreens.

In this disclosure, the term “touch sensitive surface” refers to one of: a touchscreen display, a touchpad, or any other peripheral which detects touch by a finger or a touch input tool;

In this disclosure, the term “touch sensitive surface driver” refers to one of: a touchscreen driver and a touchpad driver.

In this disclosure, the term “viewing area” or “view” refers to a region of a display, which may for example be rectangular in shape, which is used to display information and receive touch input.

In this disclosure, the term “main viewing area” or “main view” refers to the single viewing area that covers all or substantially all (e.g., greater than 95%) of the viewable area of an entire display area of a touchscreen display.

In this disclosure, the term “application” refers to a software program comprising of a set of instructions that can be executed by a processing device of an electronic device.

In this disclosure, the terms “top”, “bottom”, “right”, “left”, “horizontal” and “vertical” when used in the context of viewing areas of a display are relative to the orientation of the display when content currently displayed on the display is presented in an orientation that the content is intended to be viewed in.

The ones in the art can understand that the user can hold the electronic device in his/her right or left hand and achieve two finger input gestures with any two fingers for the user's convenience. For example, the user holds the electronic device in his/her right hand, and scroll the display with the left thumb finger on the front touchscreen area and another finger of left hand (for example, left index finger or left middle finger) or even the right index or middle finger on the back touchscreen area, which depends on the user's preference, and there is not limitation. The example embodiments of this disclosure describe the user holds the electronic device in his/her left hand and achieves the two finger input gesture with the left thumb and the left index finger.

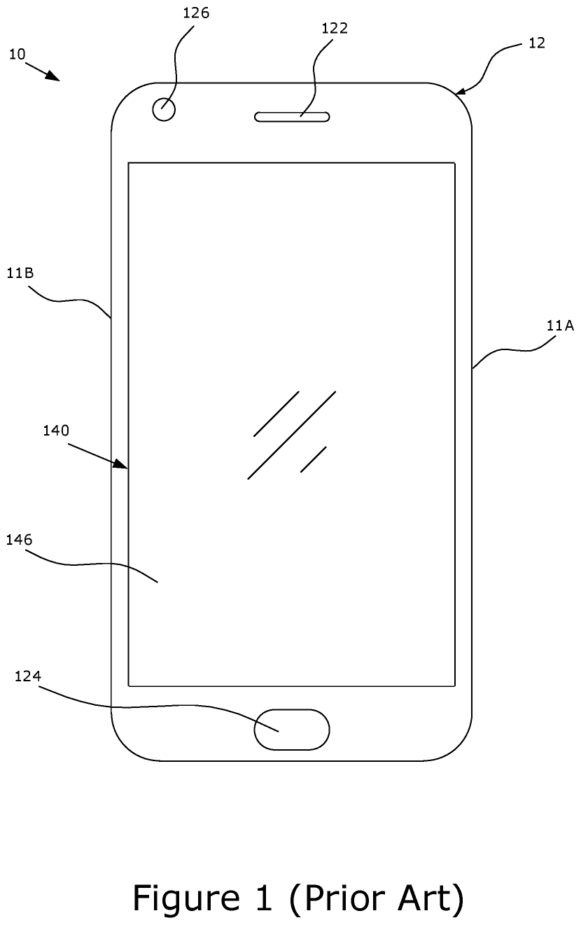

FIG. 1 depicts an electronic device 10 which may be a smartphone or a tablet. The electronic device 10 has housing 12 including a right edge 11A and a left edge 11B. The electronic device 10 includes a front touchscreen display 140 on the front side of the housing 12. The electronic device 10 also includes a speaker 122 for playing audio therethrough, an action button 124 for triggering various actions by the software running on the electronic device 10, and a front camera 126 for taking photos and recording video therethrough.

The front touchscreen display 140 is comprised of a front display 142 on which content is rendered coupled with a front touch sensing system 144 which senses touch on the screen of the first touchscreen display.

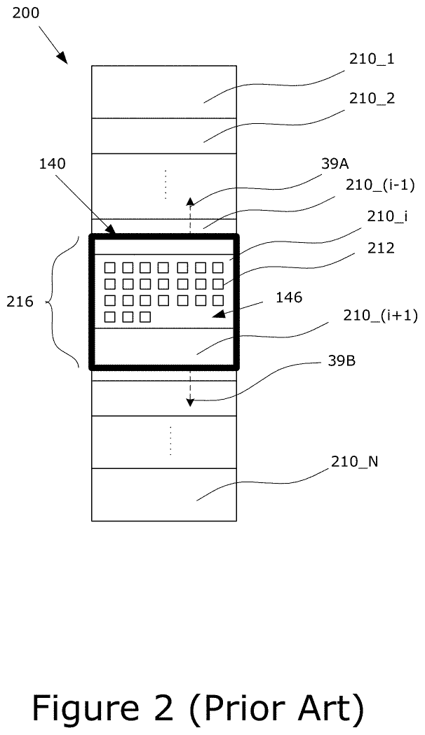

The front touchscreen display 140 has a front touchscreen display main viewing area 146 for displaying content. Often times, the content to be displayed does not fit in its entirety in the front touchscreen display main viewing area 146. FIG. 2 depicts an exemplary content in the form of a list of elements 200 to be viewed on a front touchscreen display main viewing area 146 of the front touchscreen display 140. The depicted list of elements 200 is comprised of (N) elements numbered 210_1 through 210_N (collectively “210”). In one example, each element 210 of the list of elements 200 can be an image, a video, a graphical element or text. In another example, each element 210 can be a group of sub-elements 212. For example an element 210 can be a group of photos taken on a particular date. The front touchscreen display main viewing area 146 of the front touchscreen display 140 can only show a visible content portion 216 of the elements 210 due to size limitations. For example, in the depicted example, only the 3 elements: 210_(i−1), 210_i, and 210_(i+1) can be displayed in the front touchscreen display main viewing area 146. Element 210_i can be displayed entirely in the front touchscreen display main viewing area 146, while only portions of the elements 210_(i−1) and 210_(i+1) are displayed in the front touchscreen display main viewing area 146. Accordingly, to view any of the other elements 210, such as element 210_2, which is located within the list of elements 200 and which is above the visible content portion 216, the front touchscreen display main viewing area 146 of the front touchscreen display 140 needs to scroll up the list of elements 200 in the scrolling up direction 39A. Similarly, to view any of the elements 210 which are below the visible content portion 216, the front touchscreen display main viewing area 146 of the front touchscreen display 140 needs to scroll down the list of elements 200 in the downward direction 39B.

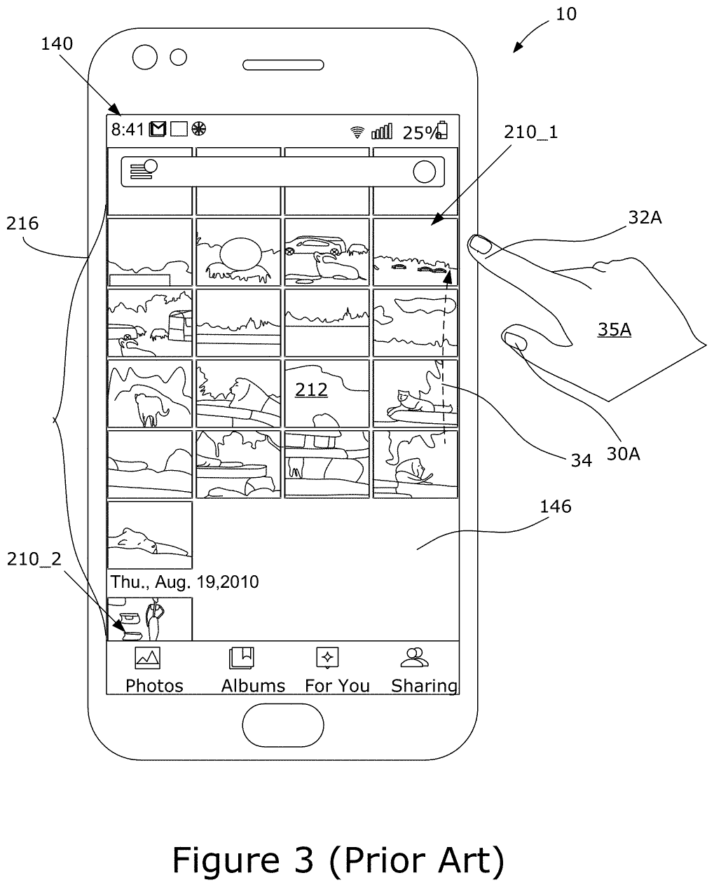

One method of scrolling up or down display content such as the list of elements 200, includes using at least one touch flick 34. With reference to FIG. 3, there is shown an electronic device 10 having a front touchscreen display 140 including a front touchscreen display main viewing area 146. Elements 210_1 and 210_2 are rendered on the front touchscreen display main viewing area 146 and form a visible content portion 216. Element 210_1 is comprised of a plurality of sub-elements 212. A human finger, such as right index finger 32A, is flicked on the screen of the front touchscreen display 140 in the direction of the touch flick 34 to cause scrolling up of the displayed elements 210 in the front touchscreen display main viewing area 146. To increase scrolling speed, the user flicks the finger, such as the right index finger 32A, in a faster manner on the screen of the front touchscreen display 140. However, as scrolling speed increases the readability of the contents being displayed is reduced during the scrolling. This is undesirable when the user is trying to find certain content.

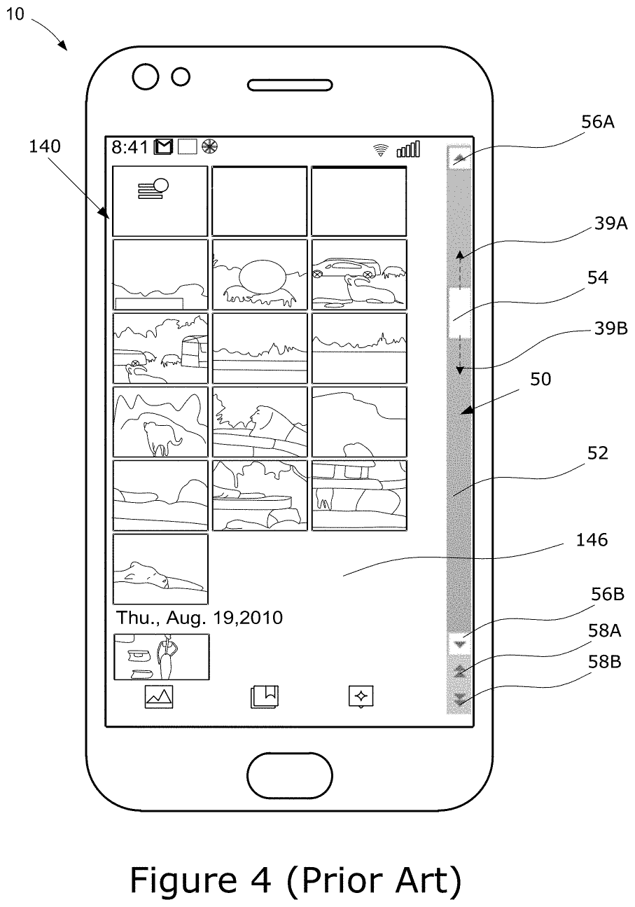

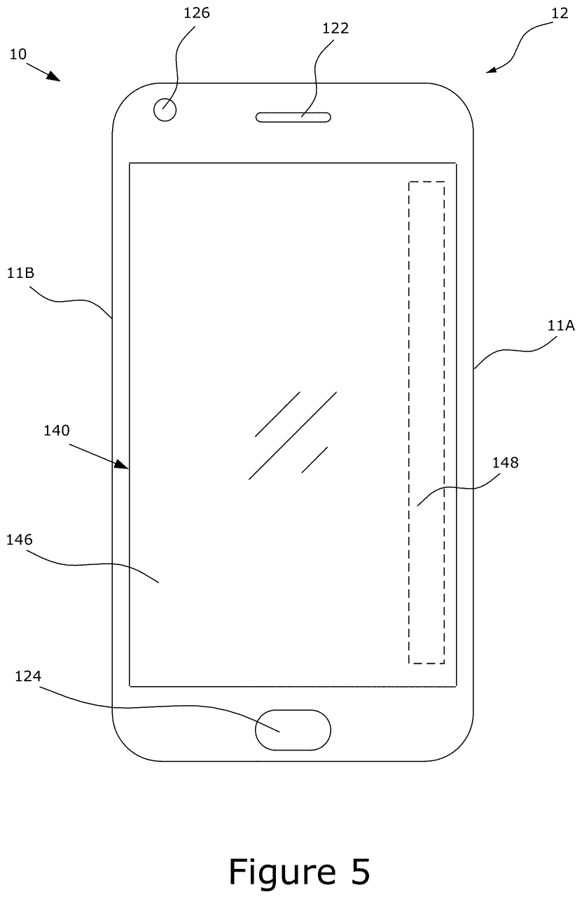

Another method of scrolling content rendered on a display involves the use of a scrollbar, such as the scrollbar 50 shown in FIG. 4. With reference to FIG. 4, the scrollbar 50 is shown rendered along the right edge of the front touchscreen display main viewing area 146 of the front touchscreen display 140. The scrollbar 50 has a scroll box 54 (also sometimes referred to as a “tab” or a “scrollbar thumb”), which is slidably movable along a scrollbar track 52. A user can touch and slide the scroll box 54 up or down to scroll the contents rendered on the front touchscreen display main viewing area 146. Alternatively, the user can tap on a unit increment control such as the scroll up unit increment element 56A or the scroll down unit increment element 56B. The unit increment element 56A and the unit increment element 56B cause screen scrolling by a small predetermined amount, such as a single line of text. Block increment scrolling can be effected by tapping on the scrollbar track 52 above or below the scroll box 54 causing scrolling by a plurality of lines. To jump to the top or bottom of a list of content elements the jump up button 58A or the jump down 58B button may be tapped. Some of the drawbacks of the scrollbar 50 is that it occupies part of the front touchscreen display main viewing area 146. As such, it tends to be rendered with small width so that it does not occupy a significant portion of the front touchscreen display main viewing area 146 thus leaving room for displayed content. Alternatively, the front touchscreen display 140 is made larger, to leave room for the content to be rendered next to the scrollbar 50, thus consuming more power and costing more to manufacture. The small width of the scrollbar 50 makes it somewhat difficult to use. Additionally, any accidental tap on the scrollbar track 52 causes unintentional block increment scrolling.

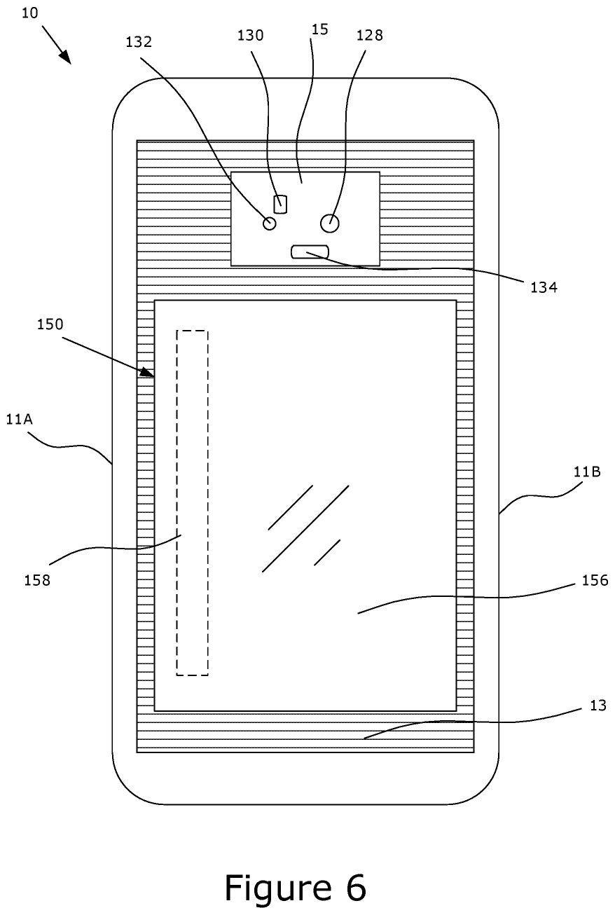

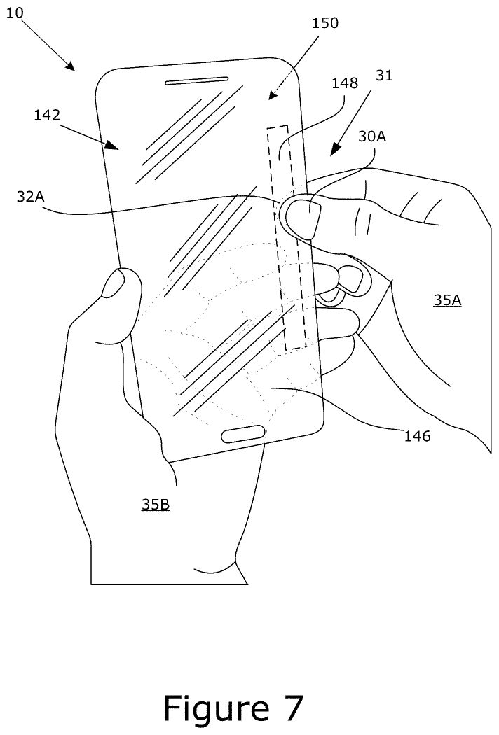

In one example embodiment, shown in FIGS. 6 and 7, the electronic device 10 features a front touchscreen display gesture response area 148 for use in scrolling. The front touchscreen display gesture response area 148 may be used in conjunction with another display gesture response area for receiving sliding gestures that can be used to scroll the contents of the main viewing area of at least one display, as will be described below.

In one embodiment, the electronic device has a touch sensitive surface on a back region thereof. For example, as shown in FIG. 6, the electronic device 10 has a back touchscreen display 150 on a back region 13 of the housing 12. The back side of the housing 12 also features a peripheral region 15. The peripheral region 15 contains a plurality of peripherals such as: a back camera 128, a camera flash 130, a light sensor 132 and a fingerprint sensor 134. These peripherals perform their respective functions as known in the art. The back touchscreen display 150 includes a back touchscreen display gesture response area 158 which may be located on the back touchscreen display viewing area 156. Each of the front touchscreen display gesture response area 148 and the back touchscreen display gesture response area 158 may receive a gesture from a human finger.

Unintended scrolling of the front display contents, such as list of elements 200, may take place when the user accidentally swipes or touches the front touchscreen display gesture response area 148. In order to prevent the unintended scrolling, or any other unintended action for that matter, the electronic device 10 is configured to only respond to gestures in which two or more gesture response areas are engaged by the user. In some example embodiments, a pinch gesture 31 in which the user engages both the front touchscreen display gesture response area 148 and the back touchscreen display gesture response area 158 is used to trigger action on the electronic device 10

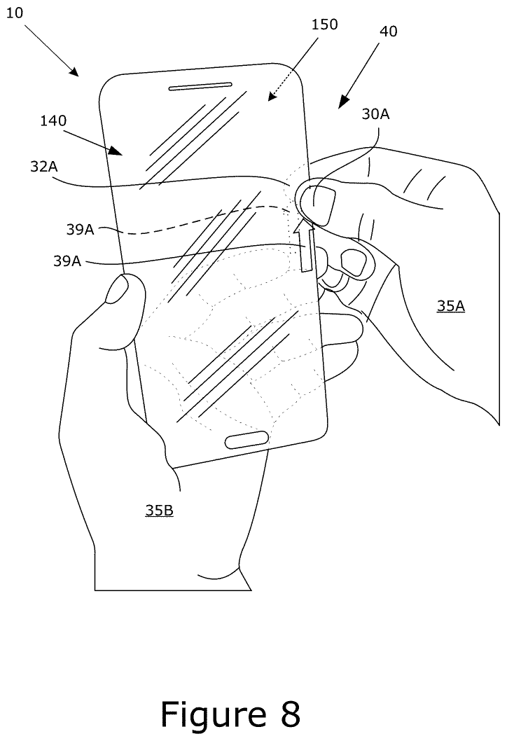

In one example embodiment, shown in FIGS. 7 and 8, scrolling the contents of the front touchscreen display 140 is done by a same direction pinch slide gesture 40. In the depicted example, the user is holding the electronic device 10 with the left hand 35B. The right hand 35A is used to scroll the contents of the front touchscreen display main viewing area 146 of the front touchscreen display 140. Initially, as shown in FIG. 7, the right hand 35A forms a pinch gesture 31 in which the right thumb 30A is in contact with the screen of the front touchscreen display 140 and the right index finger 32A is in contact with the screen of the back touchscreen display 150. Specifically, the right thumb 30A is touching the front touchscreen display gesture response area 148, and the right index finger 32A is touching the back touchscreen display gesture response area 158. The right thumb 30A and the right index finger 32A are aligned in the sense that they are touching roughly opposite sides of the housing 12. With reference to FIG. 8, the right hand 35A then slides in the upward direction 39A with both the right thumb 30A and the right index finger 32A being in contact with the screen of the front touchscreen display 140 and the back touchscreen display 150, respectively. The right thumb 30A performs a first swipe gesture in a first direction and the right index finger 32A performs a swipe gesture in a second direction consistent with the first direction of the first swipe gesture. The swiping movement of the right hand 35A in this manner comprises a same direction pinch slide gesture 40.

During the movement of the right thumb 30A and the right index finger 32A, the front touch sensing system 144 and the back touch sensing system 154 are detecting touch of the fingers along the respective touchscreen display gesture response areas (148, 158). The touches detected by the touch sensing systems (144, 154) are interpreted by the touchscreen driver 114 and produce touch events. Each touch event contains a number of input parameters such as the spatial location of the touch on the respective touchscreen display gesture response area (148, 158), the time stamp, and may optionally contain other information such as the pressure force magnitude of the fingers on the screen during the same direction pinch slide gesture 40. The touch events, produced by the touchscreen driver 114 are provided to the user interface (UI) module 316. The UI module 316 is configured to recognize any one of a plurality of predetermined gestures from the touch events. UI module 316 can track a user's finger movements across one or more of the display of the electronic device 10. In some embodiments, the detected input gesture may be determined, based on the input parameters of the plurality of touch events which comprise the detected input gesture.

Through the display screen, at any given point in time (e.g. each millisecond or any other suitable time unit), the UI module 316 tracks and stores at least a timestamp and a location (e.g. pixel position) of each detected touch event provided by the touchscreen driver 114. Based on at least the timestamp and location of each detected touch event over a given period, the UI module 316 can determine a type of the detected input gesture. For example, if a plurality of touch events are detected for only for one second and center around the same location on the display screen, the input gesture is likely a tap gesture. For another example, if a plurality of detected touch events linger over two seconds and appear to move across a small distance on the display screen, the input gesture is likely a touch flick. If a plurality of detected touch events lingers over more seconds and appear to move across a larger distance on the display screen, the input gesture is likely a swipe gesture. If a plurality of detected touch events lingers over more seconds and appear to remain in substantially the same location, then the gesture is likely a static touch gesture.

The UI module 316 may determine that a user performed a swipe gesture by detecting a plurality of touch events that indicate that a finger has moved across a touch sensitive surface without losing contact with the display screen. The UI module 316 may determine that a user performed a pinch or zoom gesture by detecting two separate swipe gestures that have occurred simultaneously or concurrently, and dragged toward (close pinch slide gesture) or away (open pinch slide gesture) from each other. The UI module 316 may determine that a user performed a rotation gesture by detecting two swipes that have occurred simultaneously forming either a pinch open slide gesture or a pinch close slide gesture.

For example, a plurality of touch events may form a single gesture. The UI module 316 compares the gestures with any one of the plurality of predetermined gestures. Accordingly, the UI module 316 may recognize a swiping gesture on the front touchscreen display gesture response area 148 in the upward direction 39A and recognize a swiping gesture on the back touchscreen display gesture response area 158 also in the upward direction 39A. The UI module 316 recognizes the two swiping gestures that happened in a same time period, on the front and back touchscreen display gesture response areas (148, 158) as a same direction pinch slide gesture 40. In response to recognizing the same direction pinch slide gesture 40, the OS 310 or any one of the applications 350, as the case may be, can perform an action. For example, an application 350 may scroll up the contents of the front touchscreen display main viewing area 146 in response to receiving an indication from the UI module 316 that a same direction pinch slide gesture 40 in the upward direction has been performed. Conversely, if the UI module 316 recognizes that the same direction pinch slide gesture was in the scroll down direction, then the contents of the front touchscreen display main viewing area 146 are scrolled down in response to the gesture. Advantageously, the contents of the front touchscreen display main viewing area 146 are scrolled controllably by the user while the contents are displayed. Averting or reducing the need for touch flicks reduces the wear on the front touch sensing system 144 which would otherwise need to handle many flicks which involve touching and applying some force to the front touch sensing system 144. Additionally, no display area is consumed by a scrollbar, thus reducing the need to use a larger front touchscreen display 140 to display the same content. A larger front touchscreen display 140 not only costs more, but is bulkier and consumes more battery power when in use. Furthermore, the possibility of accidental scrolling is reduced since no scrolling action is carried out unless the user is performing a swiping gesture on both the front and back touchscreen display gesture response areas (148, 158) simultaneously. Otherwise, accidental scrolling would require the user to perform unnecessary scrolls to adjust the screen contents back to their original state.

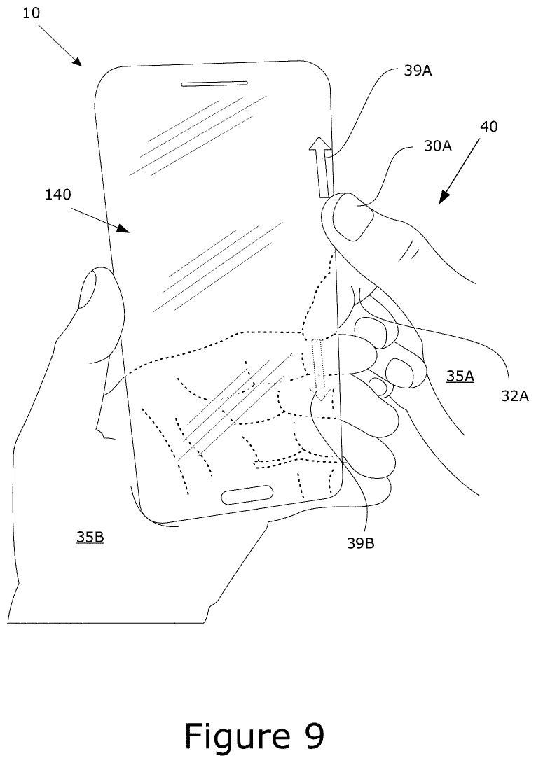

In some instances, it may be desired to jump to the top or bottom of the content to be displayed. In other instances, it may be desired to scroll the screen contents at a much higher rate. And in some other instances, it may be desired to enable auto-scrolling. Different gestures, other than the same direction pinch slide gesture 40, may be detected by the UI module 316 in which two fingers of the user simultaneously engage the front and back touchscreen display gesture response areas (148, 158). As an example, opposite direction pinch slide gestures are contemplated with reference to FIGS. 9-11.

Considering a case where the electronic device 10 was originally held in the user's hand left hand 35B and with the right hand 35A in a pinch gesture 31, as described earlier with respect to FIG. 7. Turning now to FIG. 9, the user's right hand 35A is performing an opposite direction pinch open slide gesture 42. The opposite direction pinch open slide gesture 42 starts with the right hand in a pinch gesture 31 wherein the right index finger 32A and the right thumb 30A are on opposite sides of the electronic device 10 and relatively close to each other. Then, as shown in FIG. 9, the right thumb 30A is being swiped up in the upward direction 39A, while the right index finger 32A is being swiped down in the downward direction 39B such that the right index finger 32A and the right thumb 30A move apart from each other. The movement of the right thumb 30A and right index finger 32A in this manner comprises an opposite direction pinch open slide gesture 42. The right thumb 30A and right index finger 32A are being swiped while in contact with the front and back touchscreen display gesture response areas 148 and 158, respectively. As discussed above, the touch sensing systems 144 and 154 in conjunction with the touchscreen driver 114 generate a plurality of touch events for each of the front and back touchscreen displays. The plurality of touch events are then recognized by the UI module 316 and the opposite direction pinch open slide gesture 42 is recognized.

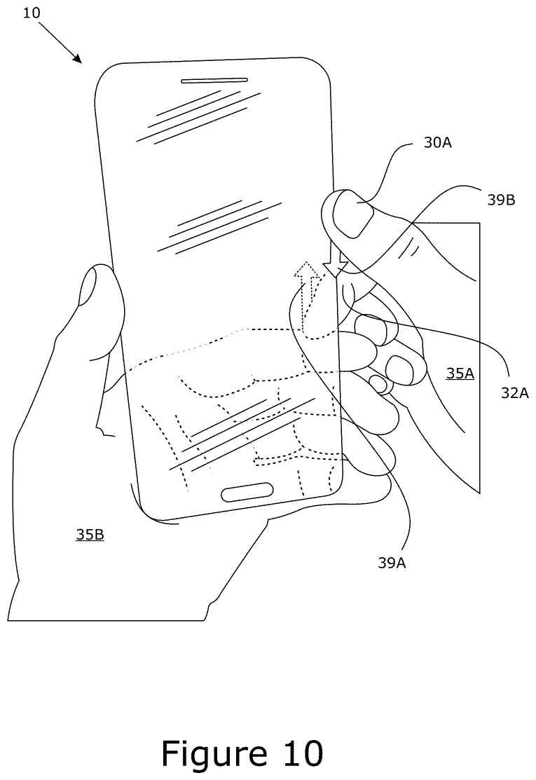

With reference to FIG. 10, an opposite direction pinch close slide gesture 44 is depicted. In this case, the UI module 316 recognizes that the right thumb 30A is initially positioned closer to the top of the front touchscreen display gesture response area 148 while the right index finger 32A is initially positioned closer to the bottom of the back touchscreen display gesture response area 158. As such the right thumb 30A and the right index finger 32A are initially positioned far from each other. The right thumb 30A is then swiped in the downward direction towards the middle of the front touchscreen display gesture response area 148. Similarly, the right index finger 32A is swiped in the upward direction towards the middle of the back touchscreen display gesture response area 158. Accordingly, the right thumb 30A and the right index finger 32A are relatively close to each other. This movement of the right thumb 30A and the right index finger 32A from an initial position in which they are far from each other to a final position in which they are close to each other comprises an opposite direction pinch close slide gesture 44. The plurality of touch events corresponding to the swipe by the right thumb 30A and right index finger 32A are recognized by the UI module 316 and the opposite direction pinch close slide gesture 44 is recognized.

In some example embodiments, the opposite direction pinch open slide gesture 42 may be recognized by the UI module 316 and used to scroll the contents of the front touchscreen display 140 upward by a faster rate than the same direction pinch slide gesture 40. In one example, the UI module 316 recognizes that the swipe of the right thumb 30A on the screen of the front touchscreen display 140 in the upward direction 39A. In response, the UI module 316 may cause upward scrolling to be performed. Changing the position of the right index finger 32A may change the speed of scrolling. For example, the position of the right index finger 32A at or near the middle of the back touchscreen display gesture response area 158 may indicate that the scrolling is to be done at normal speed. As the right index finger 32A is swiped in the downward direction 39B and is at a position closer to the lower end of the back touchscreen display gesture response area 158, an application 350 may interpret that positon of the right index finger 32A to indicate that scrolling is to be done at a slower speed, such as half the speed of normal scrolling. Similarly, the opposite direction pinch close slide gesture 44 may be used to scroll the contents of the front touchscreen display 140 down by a faster rate than the same direction pinch slide gesture 40. In this case, the right thumb 30A starts in a position near the top of the front touchscreen display gesture response area 148 and the right index finger 32A starts in a position near the bottom of the back touchscreen display gesture response area 158. The right thumb 30A is swiped along the front touchscreen display gesture response area 148 in the downward direction 39B towards the middle of the front touchscreen display gesture response area 148. Concurrently with the swiping of the right thumb 30A, the right index finger 32A is swiped along the back touchscreen display gesture response area 158 in the upward direction 39A towards the middle of the back touchscreen display gesture response area 158. The position of the right thumb 30A indicates, to the UI module 316, the scrolling speed to be used when scrolling down. For example, the initial position of the right thumb 30A near the bottom of the back touchscreen display gesture response area 158 may indicate that scrolling down is to be done at slow speed. As the right thumb 30A is swiped towards the middle of the back touchscreen display gesture response area 158, the scrolling down speed is increased. The scrolling down speed is highest when the right index finger 32A is at or near the top of the back touchscreen display gesture response area 158. Being able to dynamically control the scrolling speed between a slow, a normal, and a fast scrolling speed allows a user to easily locate specific content. For example, the user may position the right index finger 32A in a position on the back touchscreen display gesture response area 158 which causes faster scrolling, and swipe the right thumb 30A a few times. Following that, the right index finger 32A may be moved to a lower position which corresponds to a slower scrolling speed for locating the specific content.

In another example, an application 350 may be configured to scroll the contents of the front touchscreen display main viewing area 146, at a predetermined scrolling speed and by a predetermined amount, in the upward direction in response to receiving a notification that an opposite direction pinch open slide gesture 42 has been detected by the UI module 316. In this case, the UI module 316 may detect a pinch gesture 31 followed by an opposite direction pinch open slide gesture 42. In response, the application 350 scrolls the contents of the front touchscreen display main viewing area 146 by a predetermined amount. If the UI module 316 detects a release of the right thumb 30A and/or the right index finger 32A from the front touchscreen display gesture response area 148 or back touchscreen display gesture response area 158, followed by a pinch gesture 31 and another opposite direction pinch open slide gesture 42, the application 350 scrolls the contents of the front touchscreen display main viewing area 146 by the predetermined amount. Conversely, the application 350 scrolls down the display contents by a predetermined amount in response to detecting a pinch gesture 31 followed by an opposite direction pinch close slide gesture 44.

In yet another example embodiment, the UI module 316 recognizes an opposite direction pinch open slide gesture 42 and in response causes the contents of the front touchscreen display 140 to scroll up until the top of the content to be displayed is rendered on the front touchscreen display. For example with reference to FIG. 2, when the right thumb 30A is swiped up until it is at or near the top of the front touchscreen display gesture response area 148 and the right index finger 32A is swiped down until it is at or near the bottom of the back touchscreen display gesture response area 158, then the front touchscreen display 140 is scrolled until the element 210_1 is part of the visible content portion 216. Conversely, the opposite direction pinch close slide gesture 44 can be used to scroll the front display until the element 210_N is part of the visible content portion 216.

In a further example embodiment, the recognition of an opposite direction pinch open slide gesture 42 by the UI module 316 causes it to trigger auto-scrolling. In this case when the right thumb 30A is swiped up until it is at or near the top of the front touchscreen display gesture response area 148 and the right index finger 32A is swiped down until it is at or near the bottom of the back touchscreen display gesture response area 158, then the front touchscreen display 140 starts scrolling up line-by-line at a preconfigured magnitude without further intervention by the user. The automatic scrolling may continue until the right thumb 30A and right index finger 32A are swiped in the opposite directions until they are generally aligned in a pinch gesture 31. Conversely, the opposite direction pinch close slide gesture 44 can be used to trigger automatic scrolling down of the front touchscreen display 140 line-by-line at the preconfigured rate.

In some embodiments, the right thumb 30A and the right index finger 32A are swiped independently and at different speeds and may each be used to manipulate different functions in an application 350. In some example embodiments, one finger is swiped on one touch sensitive surface with while the other finger is just touching another touch sensitive surface, i.e. performing a static touch. For example, in a video playback application swipes by the right thumb 30A on the front touchscreen display gesture response area 148 may be recognized by the UI module 316 and used for adjusting a playback slider control. Adjusting a playback slider control can cause forwarding or rewinding video playback by a small time increment, such as seconds. In this case, the UI module 316 recognizes swiping the right thumb 30A in the upward direction 39A with the right index finger 32A staying (touching) on the back touchscreen display gesture response area 158, and advances the video by the granularity of 1 second or 10 seconds. In other words, the right index finger 32A is performing a static touch. Similarly, swiping the right thumb 30A in the downward direction rewinds the video back by the granularity of 1 second or 10 seconds. Conversely, swipes by the right index finger 32A on the back touchscreen display gesture response area 158 with the right thumb 30A performing a static touch on the front touchscreen display gesture response area 148, may cause forwarding or rewinding video playback by a large time increment, such as minutes. In this example, a swipe by the right index finger 32A in the upward direction 39A advances the video playback by 1 minute or 5 minutes. Similarly, swiping the right index finger 32A in the downward direction 39B may rewind the video playback by 1 minute or 5 minutes. Advantageously, both coarse and fine adjustment of a control are provided. For a control which is associated with system parameters, this permits both coarse and fine adjustment of the system parameter associated with the control as described below.

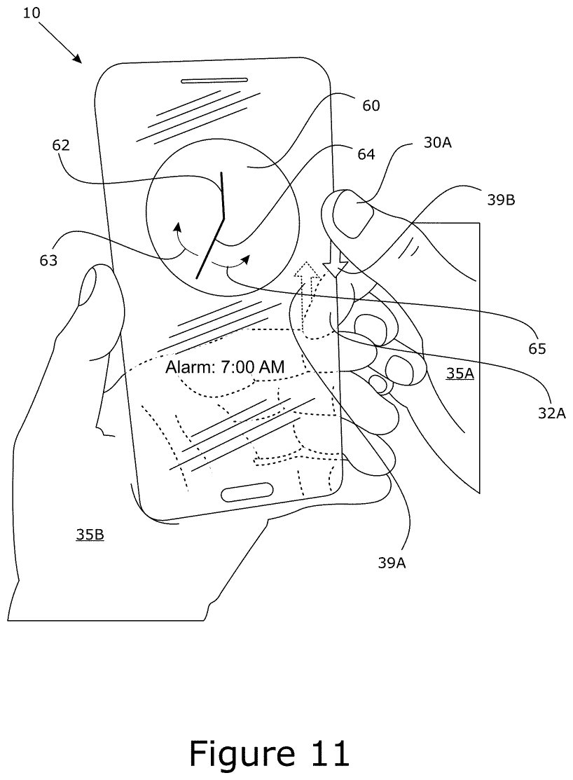

The opposite direction pinch (open or close) slide gestures (42, 44) may be recognized by the UI module 316 and used to rotate an object on the display. In some examples, the pinch open or close slide gestures (42, 44) may be recognized by the UI module 316 and used to manipulate user interface controls which control system parameters such as any rotating dial control including a volume control, a brightness controls and the like. As an example, FIG. 11 depicts an electronic device 10 displaying the user interface of an analog alarm clock 60 on the front touchscreen display 140 thereof. The analog alarm clock has an hour hand 62 and a minute hand 64. The opposite direction pinch slide gestures (42, 44) may be used to set the analog alarm clock 60. For example, the right thumb 30A may control the minute hand 64. When the right thumb 30A is swiped in the upward direction 39A, this may move the minute hand 64 in the clockwise direction 63. When the right thumb 30A is swiped in the downward direction 39B, this may move the minute hand 64 in the counter clockwise direction. Similarly, the right index finger 32A may control the hour hand 62. When the right index finger 32A is swiped in the upward direction 39A, they may move the hour hand 62 in the clockwise direction. When the right index finger 32A is swiped in the downward direction 39B, they may move the hour hand 62 in the counter clockwise direction 65.

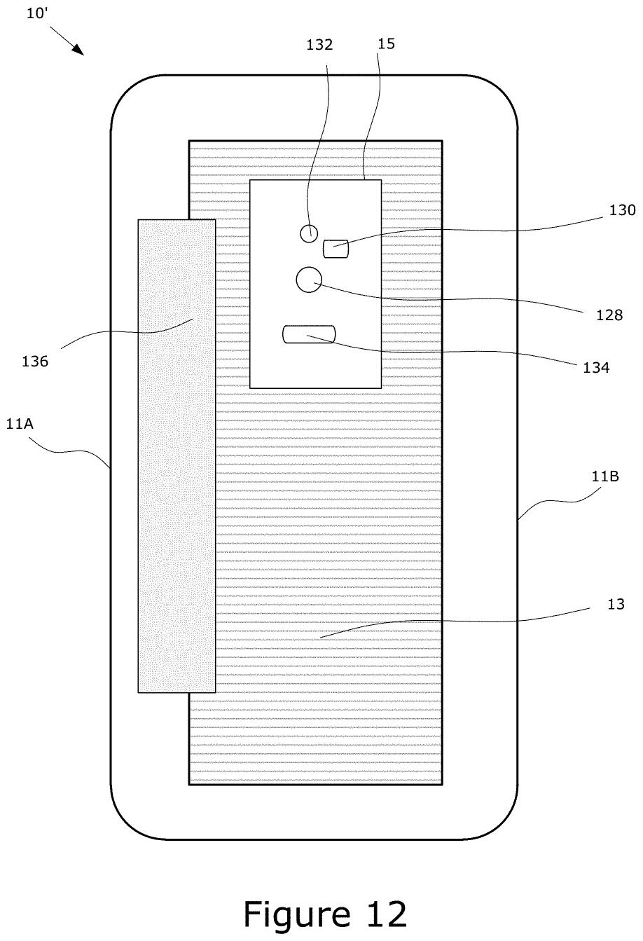

While, the above-described electronic device 10 has a front touchscreen display 140 and a back touchscreen display 150, the above-described methods may be performed on an electronic device having a front touchscreen display 140 and a back touchpad 136. For example, with reference to FIG. 12, the back side of an electronic device 10′ is shown. The electronic device 10′ has a back region 13 including a peripheral region 15 containing a back camera 128, a light sensor 132, a camera flash 130 and fingerprint sensor 134 described above. The electronic device 10′ has a back touchpad 136 which can detect touch. The back touchpad 136 detects touch via a touchpad sensing system 138. A touchpad driver 317 processes the detected touch and generates touch events similar to those generated by the touchscreen driver 114. Accordingly, the same direction pinch slide gesture 40, the opposite direction pinch open slide gesture 42 and the opposite direction pinch close slide gesture 44 can all be performed on the electronic device 10′ with the right thumb 30A touching the front touchscreen display gesture response area 148 and the right index finger 32A touching the touchpad 136, i.e. the touchpad 136 achieves the same touch sensing functions as the back touchscreen display gesture response area 158.

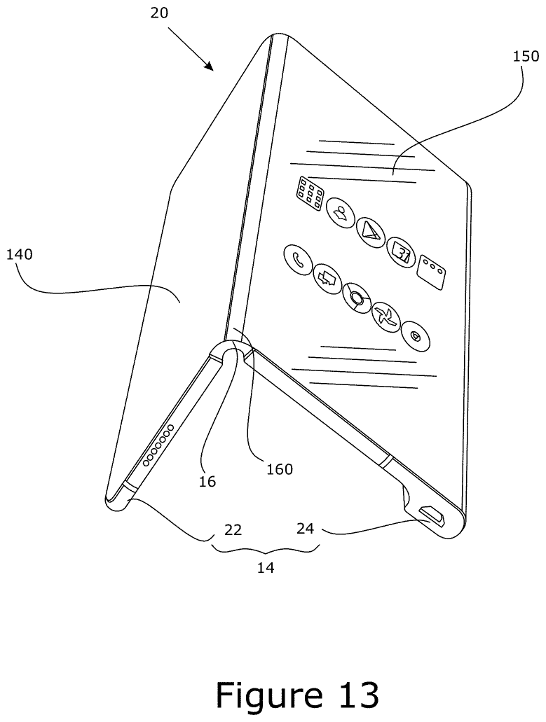

There has been an increasing research and commercial interest in the development of electronic devices, such as mobile phones that have a flexible display screen which can be folded or formed into different form factors (hereinafter referred to as foldable electronic devices). A foldable device can have two or three touchscreen displays. With reference to FIG. 13, there is shown a foldable electronic device 20 having a housing 14 comprised of a front housing portion 22 and a back housing portion 24. The foldable electronic device 20 may contain a single flexible touchscreen display, or, as shown in FIG. 13, three touchscreen displays: 140, 150 and 160. Each of the front touchscreen display 140, back touchscreen display 150 and edge touchscreen display 160 includes a respective display 142, 152 and 162, and a respective touch sensing system 144, 154 and 164 respectively. The housing 14 features a folding edge 16 which acts as a hinge between the front housing portion 22 and back housing portion 24. FIG. 13 shows the foldable electronic device 20 in a tent configuration and being placed on a generally horizontal surface.

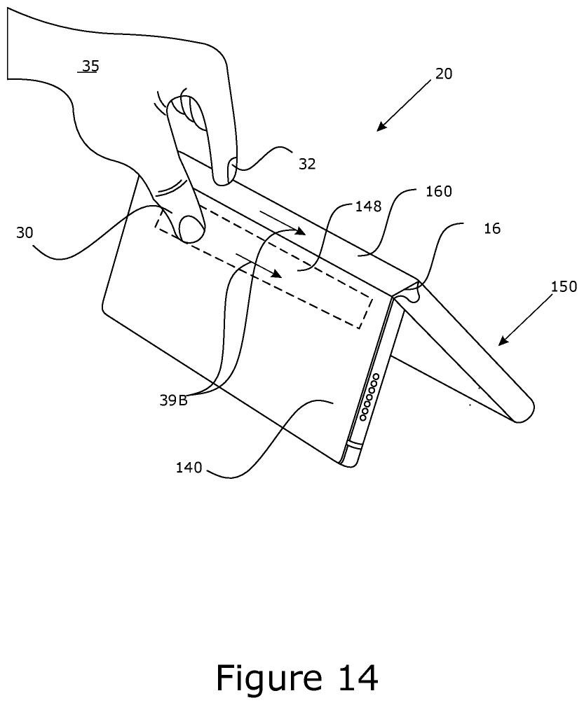

The above-described gestures, used with electronic devices 10 and 10′ may also be used with foldable electronic device 20. For example, with reference to FIG. 14, a same direction pinch slide gesture 40 is performed by a user's hand 35. Specifically, a thumb 30 is performing a swipe on the front touchscreen display gesture response area 148 in the direction 39B and an index finger 32 performing a swipe on the edge touchscreen display 160 also in the direction 39B. The direction 39B is a downward direction if the foldable electronic device 20 was held in a portrait orientation. In the depicted embodiment, the direction 39B is a right direction. In response to detecting the same direction pinch slide gesture 40 by the UI module 316, in the same manner as described above, an application 350 may change the content rendered on the main viewing area of either the front touchscreen display 140 or the back touchscreen display. As an example, a first user may be showing a slide show of photos to a second user. In this case, the first user is using the hand 35 to perform the same direction pinch slide gesture 40, and a photo viewing application may render the next photo in a photo collection on the back touchscreen display 150, in response to the same direction pinch slide gesture 40. In this embodiment, the same content may be rendered on both the front touchscreen display 140 and the back touchscreen display 150.

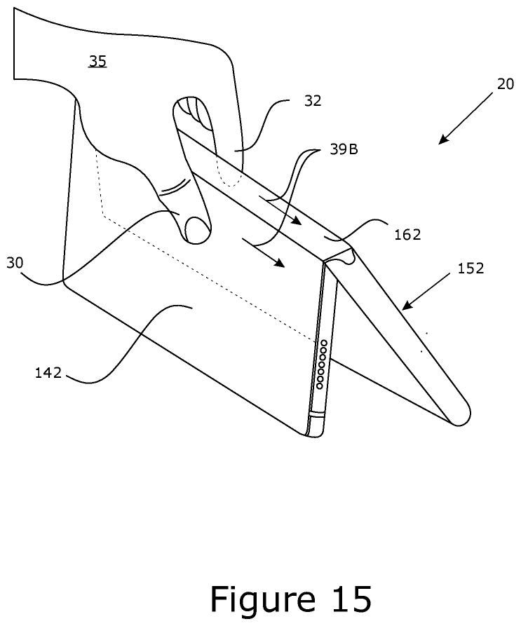

In another example embodiment, shown in FIG. 15, the same direction pinch slide gesture 40, recognized by the UI module 316, is performed by the hand 35 with the thumb 30 swiping the front touchscreen display 140 while the index finger 32 swipes the back touchscreen display 150. In one example, the same direction pinch slide gesture 40 may be used to replace the content of the edge touchscreen display 160 with different content. For example, the edge touchscreen display may initially be displaying weather information. In response to the same direction pinch slide gesture 40, the edge touchscreen display 160 may instead display a stock ticker.

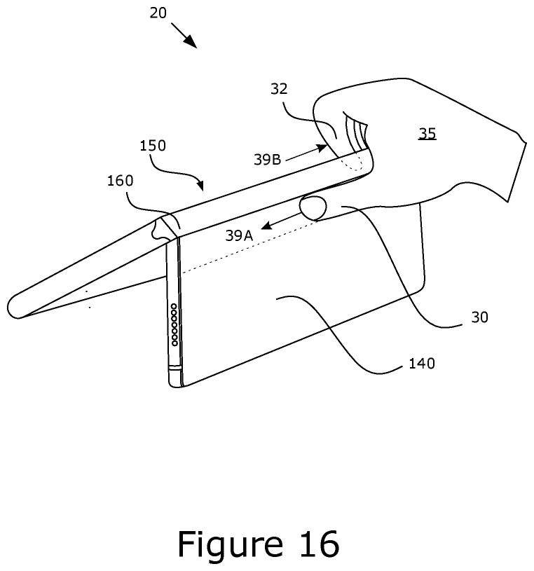

In yet another embodiment, shown in FIG. 16, an opposite direction pinch open slide gesture 42, recognized by the UI module 316, is performed by the hand 35 with the thumb 30 swiping on the front touchscreen display 140 and the index finger 32 swiping on the back touchscreen display 150. The opposite direction pinch open slide gesture 42 may be used to trigger a number of actions in applications 350 as described earlier, including scrolling, or controlling UI control such as a slider control.

While specific gestures were shown in the figures, it would be apparent to persons skilled in the art that other variations of such gestures are possible. For example gestures involving the fingers touching all three touchscreen displays 140, 150 and 160 are possible. In other examples, gestures involving touching only the edge touchscreen display 160 and the back touchscreen display 150 are also contemplated.

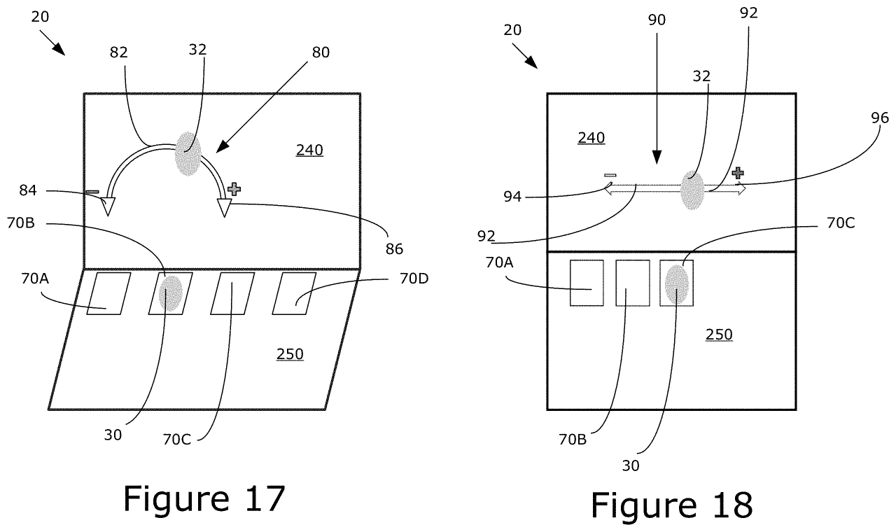

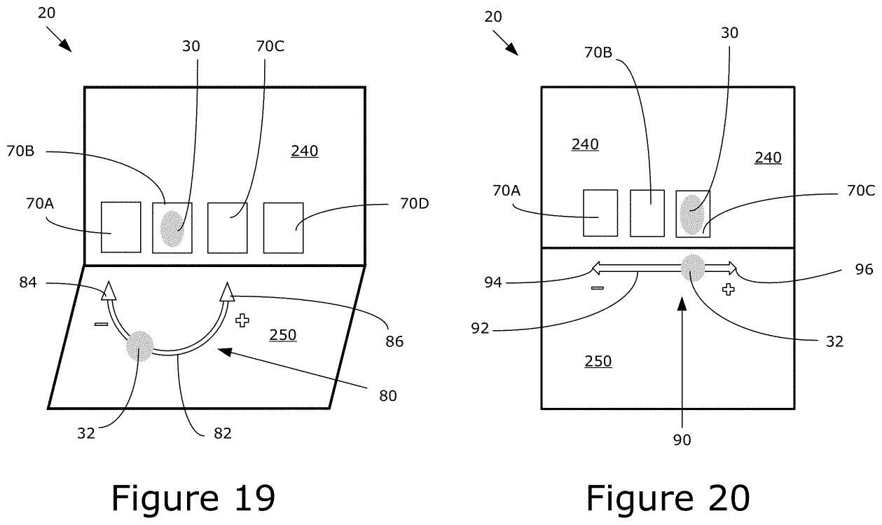

FIGS. 17-20 depict another example embodiment of the present disclosure in which the foldable electronic device 20 has a top touchscreen display 240 and a bottom touchscreen display 250 which are hingedly connected to one another. In FIGS. 17 and 19, the foldable electronic device 20 is configured such that there is an obtuse angle between the top touchscreen display 240 and the bottom touchscreen display 250. On the other hand, FIGS. 18 and 20 show the foldable electronic device 20 configured such that the top touchscreen display 240 and the bottom touchscreen display 250 are in the same plane.

In some examples of the embodiments, a two finger input gesture, recognized by the UI module 316, may be used to manipulate a user interface control associated with a system configuration parameter. For example, manipulating a user interface control may allow the adjustment of one of an audio volume, a display brightness, a display contrast, or any other system configuration parameter. The user interface control may be a linear slider control or a rotary slider control. In example shown in FIG. 17, on the viewing area of bottom touchscreen display 250 there is rendered a plurality of user interface selection controls in the form of soft buttons 70A-70D (collectively “70”). When the UI module 316 recognizes a static touch on one of the soft buttons 70A-70D, a corresponding user interface control is displayed on the top touchscreen display 240. For example, as shown in FIG. 17, the touch of a thumb 30 is shown on the soft button 70B. The static touch of the thumb 30 is detected by the UI module 316. In response to that static touch on the soft button 70B, a rotary slider control is rendered on the top display 240, for example by the UI module 316. The rotary slider control persists on the top touchscreen display 240 as long as the thumb 30 is performing a static touch on the soft button 70B.

The rotary slider control 80 has a first end 84, a second end 86, and a track 82 extending between the first end 84 and the second end 86. The rotary slider control 80 is associated with a system parameter. The rotary slider control 80 may receive a finger touch on the track 82, and the position of the finger on the track 82 determines a corresponding value for the system parameter. For example, the system parameter is at its minimum value when the UI module 316 recognizes that a finger is touching the track at or near the first end 84. Conversely, the system parameter is at its maximum value when a finger is recognized to touch the track 82 at or near the second end 86. While the thumb 30 is on the soft button 70B, an index finger 32 may be placed on and moved (swiped) along the track 82 to adjust the system parameter associated with the rotary slider control 80.

FIG. 18 depicts a similar embodiment as FIG. 17, but using a linear slider control 90. In this embodiment, the UI module 316 detects a static touch of a thumb 30 on the soft button 70C. In response to the static touch, the UI module 316 causes the linear slider control 90 to be displayed on the top touchscreen display 240. The linear slider control 90, has a first end 94, a second end 96 and a track 92 extending between the first end and the second. While the static touch is detected, a swipe by an index finger 32 placed on the track 92 either towards the first end 94 or the second end 96, detected by the UI module 316, causes the system parameter associated with the linear slider control 90 to be adjusted.

FIGS. 19 and 20 depicts similar embodiments as FIGS. 17 and 18, wherein the soft buttons 70 are displayed on the top touchscreen display 240 while the slider controls (80, 90) are displayed on the bottom touchscreen display 250.

Advantageously, the embodiments of FIGS. 17-20 allow different user interface slider controls to be displayed within the same display viewing area by tapping a different soft button 70. Furthermore, using a two finger input gesture eliminates unintentional display or activation of a slider control in the case of an accidental swipe on a touchscreen display.

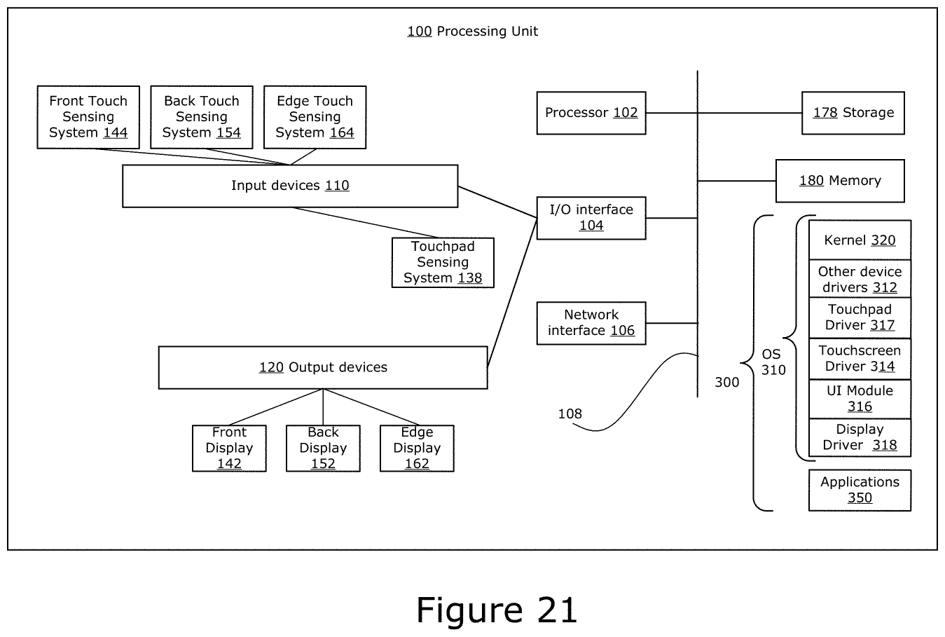

FIG. 21 depicts a processing unit 100, which may be used to implement the electronic devices 10, 10′ and 20. The processing unit 100 may be used to execute machine readable instructions, in order to implement methods and examples described herein. Other processing units suitable for implementing embodiments described in the present disclosure may be used, which may include components different from those discussed below. Although FIG. 17 shows a single instance of some components, there may be multiple instances of each component in the processing unit 100.

The processing unit 100 may include one or more processors 102, such as a microprocessor, a microcontroller, an application-specific integrated circuit (ASIC), a field-programmable gate array (FPGA), a dedicated logic circuitry, or combinations thereof. The processing unit 100 may also include one or more input/output (I/O) interfaces 104, which may enable interfacing with one or more appropriate input devices 110 and/or output devices 120.

The input devices 110 may include a front touch sensing system 144 associated with the front touchscreen display 140, a back touch sensing system 154 associated with the touchscreen display 150. Optionally, for some devices, such as the foldable electronic device 20, the input devices 110 may also include an edge touch sensing system 164 associated with an edge touchscreen display 160. For other devices, such as electronic device 10′, the input device 110 includes a touchpad sensing system 138 associated with the touchpad 136.

The output devices 120 may include a front display 142 which is part of a front touchscreen display 140. In some embodiments the output devices 120 may include a back display 152 which is part of a back touchscreen display 150. In some embodiments, the output devices 120 include an edge display 162 which is part of an edge touchscreen display 160.

The processing unit 100 may include one or more network interfaces 106 for wired or wireless communication with a network (e.g., an intranet, the Internet, a peer-to-peer (P2P) network, a wide area network (WAN) and/or a local area network (LAN) or other node. The network interfaces 106 may include wired links (e.g., Ethernet cable) and/or wireless links (e.g., one or more antennas) for intra-network and/or inter-network communications.

The processing unit 100 may also include one or more storage unit(s) 178, which may include a mass storage unit such as a solid state drive, a hard disk drive, a magnetic disk drive and/or an optical disk drive. The processing unit 170 may include one or more memories 180, which may include a volatile (e.g. random access memory (RAM)) and non-volatile or non-transitory memories (e.g., a flash memory, magnetic storage, and/or a read-only memory (ROM)). The non-transitory memory(ies) of memories 180 store programs 300 that include software instructions for execution by the processor 102, such as to carry out examples described in the present disclosure. In example embodiments the programs 300 include software instructions for implementing operating system (OS) 310 and applications 350.

The OS 310 can include kernel 320 for task switching, touchscreen driver 314 coupled with touch sensing systems 144, 154 and 164 for generating touch events as discussed above, and a UI module 316 for recognizing gestures formed by the touch events. The OS 310 also includes a touchpad driver 317 for devices including a touchpad, a display driver 318 coupled with the displays 142, 152 and 162, and other device drivers 312 for various peripherals. The memory 180 also stores one or more applications 350 which render content on any one of the displays 142, 152 and 162 via the display driver 318.

In some examples, memory 180 may include software instructions of the processing unit 100 for execution by the processor 102 to carry out the display content modifications described in this disclosure. In some other examples, one or more data sets and/or modules may be provided by an external memory (e.g., an external drive in wired or wireless communication with the processing unit 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 108 providing communication among components of the processing unit 100, including the processor(s) 102, I/O interface(s) 104, network interface(s) 106, storage unit(s) 178 and/or memory(ies) 180. The bus 108 may be any suitable bus architecture including, for example, a memory bus, a peripheral bus or a video bus.

The input device(s) 110 may include other components which are not shown such as a keyboard, a mouse, a microphone, and accelerometer, and/or a keypad). The output device(s) 120 may include other components which are not shown such as an LED indicator and a tactile generator.

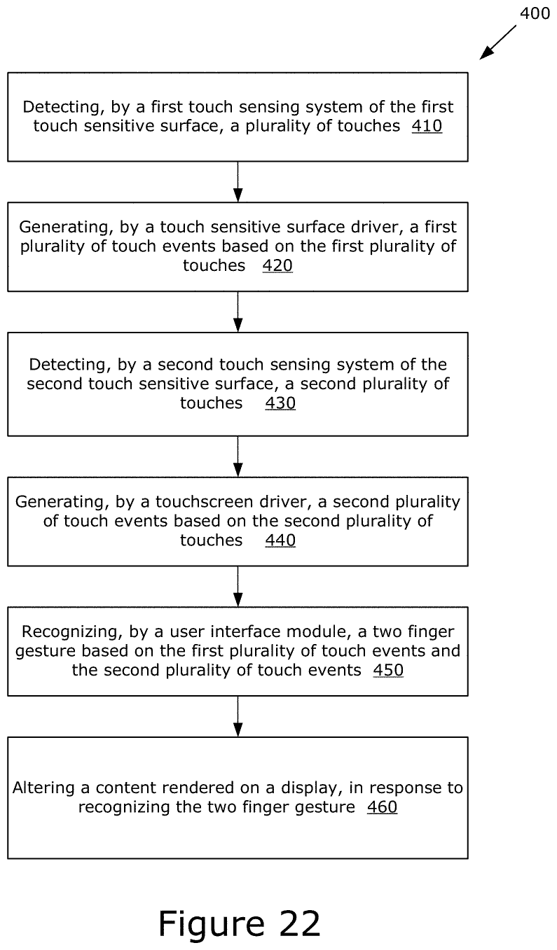

FIG. 22 depicts a method 400 for altering a content rendered on the first touchscreen display or the second touchscreen display. At step 410, a first touch sensing system detects a first plurality of touches on a first screen of the first touchscreen display. At step 420, a touchscreen driver 314 generates a first plurality of touch events based on the first plurality of touches detected by the first touch sensing system. At step 430, a second touch sensing system detects a second plurality of touches on a second screen of the second touchscreen display. At step 440, the touchscreen driver 314 generates a second plurality of touch events based on the second plurality of touches detected by the second touch sensing system. At step 450, a UI module 316, recognizes a pinch gesture from the first plurality of touch events and the second plurality of touch events. At step 460, the content rendered on the first touchscreen display or on the second touchscreen display is altered in response to recognizing the pinch slide gesture.

The plurality of touch events provided by the touchscreen driver 314 (or the touchpad driver 317 in case of the touch sensitive surface being a touch pad) contain both location information and a time stamp. A swipe is comprised of a plurality of touch events which differ in location and time. Accordingly, the UI module 316 which receives the touch events and can compute a velocity for each of a first swipe and a second swipe. For example, the velocity of a first swipe detected on a first touch sensitive surface may be denoted V₁ and the velocity of a second swipe detected on a second touch sensitive surface may be denoted V₂. The UI module 316 then classifies the gestures as follows:

When V₁=V₂+delta, then the second swipe is in the same direction as the first swipe, and the gesture is a same direction pinch slide gesture.

When V₁=−V₂+delta, then the first swipe is in an opposite direction to the second swipe, and the gesture is an opposite direction pinch slide gesture.

When V₁=0 and V₂>0, then the first swipe is a static touch while the second swipe is used to manipulate a slider user interface control.

Certain adaptations and modifications of the described embodiments can be made. Therefore, the above discussed embodiments are considered to be illustrative and not restrictive.

1. A method for controlling a foldable electronic device that comprises a first touchscreen device having a first touch sensitive surface and a second touchscreen device having a second touch sensitive surface, the first touchscreen device and the second touchscreen device being hingedly connected to one another, the method enabling control of a plurality of parameter control functions using a first finger and a second finger of one hand, comprising:
rendering, on the first touch sensitive surface, a plurality of selectable soft buttons that each correspond to a respective parameter control function of the plurality of parameter control functions;
detecting, on the first touch sensitive surface, a first input gesture selecting one of the plurality of selectable soft buttons;
detecting a second input gesture at a location on the second touch sensitive surface that can be touched by the second finger of the one hand while the first finger of the one hand performs the first input gesture; and
adjusting, based on the second input gesture, a parameter of the respective parameter control function corresponding to the selectable soft button selected by the first input gesture.

2. (canceled)

3. (canceled)

4. (canceled)

5. (canceled)

6. (canceled)

7. (canceled)

8. (canceled)

9. (canceled)

10. (canceled)

11. A foldable electronic device configured to enable control of a plurality of parameter control functions using a first finger and a second finger of one hand, the device comprising:
a first touchscreen device having a first touch sensitive surface and a second touchscreen device having a second touch sensitive surface, the first touchscreen device and second touchscreen device being hingedly connected to one another;
a processor connected to exchange signals with the first touchscreen device and the second touchscreen device;
a non-transitory memory coupled to the processor and storing instructions that, when executed by the processor, configure the processor to:
render, on the first touch sensitive surface, a plurality of selectable soft buttons that each correspond to a respective parameter control function of the plurality of parameter control functions;
detect, on the first touch sensitive surface, a first input gesture selecting one of the plurality of selectable soft buttons;
detect a second input gesture at a location on the second touch sensitive surface that can be touched by the second finger of the one hand while the first finger of the one hand performs the first input gesture; and
adjust, based on the second input gesture, a parameter of the respective parameter control function corresponding to the selectable soft button selected by the first input gesture.

12. (canceled)

13. (canceled)

14. (canceled)

15. (canceled)

16. (canceled)

17. (canceled)

18. (canceled)

19. (canceled)

20. A non-transitory computer readable medium storing instructions for execution by a processor of a foldable elector device that includes a first touchscreen device having a first touch sensitive surface and a second touchscreen device having a second touch sensitive surface, the first touchscreen device and second touchscreen device being hingedly connected to one another, the instructions being configured to enable control of a plurality of parameter control functions using a first finger and a second finger of one hand, the instructions when executed by the processor of an electronic device, configure the processor to:
render, on the first touch sensitive surface, a plurality of selectable soft buttons that each correspond to a respective parameter control function of the plurality of parameter control functions;
detect, on the first touch sensitive surface, a first input gesture selecting one of the plurality of selectable soft buttons;
detect a second input gesture at a location on the second touch sensitive surface that can be touched by the second finger of the one hand while the first finger of the one hand performs the first input gesture; and
adjust, based on the second input gesture, a parameter of the respective parameter control function corresponding to the selectable soft button selected by the first input gesture.

21. The method of claim 1, wherein the first input gesture corresponds to a static touch at a location of the selected selectable soft button.

22. (canceled)

23. The method of claim 21, comprising, in response to the first input gesture, rendering a user interface slider control on the second touch sensitive surface at a region that can be touched by the second finger of the one hand when the first finger of the one hand performs the first input gesture, wherein the slider control has a track element between a first end and a second end, wherein the detected second input gesture indicates, based on a location of the second input gesture on the track element, a value of the parameter of the respective parameter control function.

24. The method of claim 23, wherein detecting the second input gesture includes detecting a swipe gesture along the track element of the slider control.

25. The method of claim 1 wherein the plurality of parameter control functions include functions that control at least one of:
audio volume;
display brightness; and
display contrast.

26. The method of claim 23, wherein the slider control is a linear slider control.

27. The method of claim 23, wherein the slider control is a rotary slider control.

28. The electronic device of claim 11, wherein the first input gesture corresponds to a static touch at a location of the selected selectable soft button.

29. (canceled)

30. The electronic device of claim 28, wherein the instructions configure the processor to render a user interface silder control on the second touch sensitive surface at a region that can be touched by the second finger of the one hand when the first finger of the one hand performs the first input gesture, the slider control having a track element between a first end and a second end, wherein the detected second input gesture indicates, based on a location of the second input gesture on the track element, a value of the parameter of the respective parameter control function.

31. The electronic device of claim 30, wherein the instructions configure the processor to detect the second input gesture based on detecting a swipe gesture along the track element of the slider control.

32. The electronic device of claim 11, wherein the plurality of system parameter control functions include a function that controls one of:
audio volume;
display brightness; and
display contrast.

33. (canceled)

34. (canceled)

35. The method of claim 1 wherein the plurality of parameter control functions each correspond to a respective system configuration parameter for the electronic device.

36. The method of claim 1 wherein a user interface control is rendered in response to a static touch of one of the plurality of selectable soft buttons by the first finger of the one hand and wherein the user interface control can be manipulated by a swipe gesture by the second finger of the one hand.

37. The device of claim 11 wherein the plurality of parameter control functions each correspond to a respective system configuration parameter for the electronic device.

38. The device of claim 11 wherein the instructions to configure the processor to render a user interface control in response to a static touch of one of the plurality of selectable soft buttons by the first finger of the one hand, wherein the user interface control can be manipulated by a swipe gesture by the second finger of the one hand.

39. The device of claim 11 wherein the first touchscreen device and the second touchscreen device can be folded relative to each other to enable the first touch sensitive surface and the second touch sensitive surface to be simultaneously viewed by a user while the user performs the first input gesture and the second input gesture using the one hand.

40. The device of claim 39 wherein the second input gesture can be used to input multiple different values and the instructions configure the processor to display, in response to the second input gesture, a control element on the second touch sensitive surface visually indicating a relative magnitude of an input value.
